(19) United States
(12) Patent Application Publication
(10) Pub. No.: US 2006/0153488 A1
(43) Pub. Date: Jul. 13, 2006

(54) Optical sensor

(76) Inventor: Yoshihiro Takiguchi, Shizuoka (JP)

Correspondence Address: DRINKER BIDDLE & REATH (DC), 1500 K STREET, N.W., SUITE 1100, WASHINGTON, DC, 20005-1209, US

(21) Appl. No.: 10/522,812

(22) PCT Filed: Aug. 1, 2003
(86) PCT No.: PCT/JP03/09831

§ 371 Date: Sep. 12, 2005

(30) Foreign Application Priority Data
Aug. 1, 2002 (JP) 2002225262

(51) Int. Cl. G02B 6/00

(52) U.S. Cl. 385/12

(57) ABSTRACT

A light detection device 1 comprises a photocathode 30 and an electron multiplier 50, which are positioned inside a vacuum container 10. A photomultiplier tube is arranged from these components. Light detection device 1 is equipped with an optical fiber 20, through which a light signal L flows, and photocathode 30 is formed on an end face 27 of optical fiber 20.

### TECHNICAL FIELD

This invention concerns a light detection device that includes an optical part, such as a photomultiplier tube.

### BACKGROUND ART

FIG. 3 is a schematic view of a prior-art light detection device. This prior-art light detection device includes a photomultiplier tube 80 and an image forming system 90. Photomultiplier tube 80 has a structure, wherein an electrode 83a, a photocathode 85, an aperture electrode 83b, a focusing electrode 83c, an electron multiplier 87, and a readout electrode 83d are positioned inside a vacuum container 81 in that order from one end face to the other end face of vacuum container 81. Image forming system 90 comprises lens systems 91 and 93, positioned so as to oppose each other, a wavelength selection filter 95, positioned between lens system 91 and lens system 93, and an adjustment part 97 for fine adjustment of the position of lens system 93. The necessary wavelength component within a light signal L is selected by wavelength selection filter 95.

Light signal L from a light source S is imaged onto photocathode 85 by image forming system 90. By fine adjustment of lens system 93 using adjustment part 97, the adjustment of the imaging is performed. By this imaging, electrons inside photocathode 85 are excited and photoelectrons are emitted into the vacuum (external photoemission effect). Of the photoelectrons that are emitted, the photoelectrons that pass through an opening 82 of aperture electrode 83b are focused on electron multiplier 87 by focusing electrode 83c. By secondary electron emission occurring repeatedly at electron multiplier 87, the electric current is amplified. This is read out as the output signal via readout electrode 83d.

With the above-described light detection device, when the intensity of light signal L that is made incident on photocathode 85 is extremely low, the signal-to-noise ratio in measurement is strongly affected by thermal noise. That is, as thermal noise increases, the signal-to-noise ratio in measurement worsens. It is thus important to reduce the thermal noise. The thermal noise can be reduced by lowering the temperature of photocathode 85 and by making the area of photocathode 85 small. In prior arts, the temperature of photocathode 85 is lowered by positioning a Peltier cooler 89 in the vicinity of photocathode 85 or by reducing the effective area of photocathode 85 by means of aperture electrode 83b. The area corresponding to the opening area of opening 82 of aperture electrode 83b corresponds to being the effective area of photocathode 85.

### DISCLOSURE OF THE INVENTION

With the prior-art light detection device, the photoelectrons that have passed through opening 82 of aperture electrode 83b are focused onto electron multiplier 87. In order to make effective use of the photoelectrons emitted from photocathode 85, the number of photoelectrons passing through opening 82 must be made high, and image forming system 90 and adjustment part 97 are thus required. Also by providing aperture electrode 83b, a lens effect is caused by the electric field formed by photocathode 85 and aperture electrode 83b. Focusing electrode 83c is required to correct for this effect. The prior-art light detection device thus had to be equipped with image forming system 90, adjustment part 97, focusing electrode 83c, etc., and these impeded the making of the device compact.

An object of this invention is to provide a light detection device, which can be made compact while being made low in thermal noise.

This invention's light detection device comprises an optical fiber, having an end face that serves as a light exiting surface, and a photoelectron emitting part, formed on the end face and emitting photoelectrons based on light exiting from the end face.

With this invention, since a photoelectron emitting part (for example, a photocathode) is formed on an end face of an optical fiber, an image forming system for imaging light onto the photoelectron emitting part and an adjustment part for fine adjustment of the lens of the image forming system are made unnecessary. Since an aperture electrode is also made unnecessary by the same reason, the lens effect, caused by the electric field formed by the photoelectron emitting part and the aperture electrode, will not occur. Thus by this invention, a focusing electrode for correcting the lens effect does not have to be disposed. Also, since the photoelectron emitting part is formed on the end face of the optical fiber, the photoelectron emitting part can be made compact. Due to the above reasons, a light detection device can be made compact by this invention.

Also, since the photoelectron emitting part can be made compact as described above, the thermal noise can be reduced. The signal-to-noise ratio in measurement can thus be made satisfactory by this invention.

With the present invention, a structure is preferably arranged wherein the optical fiber includes a core part, at least a part of the end face includes the core part, and the photoelectron emitting part is formed just on the core part of the end face. Since the photoelectron emitting part can thus be made even more compact, the thermal noise can be reduced and the signal-to-noise ratio in measurement can be made satisfactory.

With the present invention, a structure is preferably arranged wherein a diffraction grating for wavelength selection is formed on the core part. With this invention, a structure is preferably arranged that includes a light shielding cladding disposed on the surface of the optical fiber in order to prevent leakage of light from the optical fiber. With this invention, a structure is preferably arranged wherein the optical fiber includes another end face that serves as a light incidence surface and the light detection device includes an optical fiber connector, which is mounted to the other end face. With this invention, a structure is preferably arranged that includes a cooling part for lowering the temperature of the photoelectron emitting part.

### BRIEF DESCRIPTION OF THE DRAWINGS

FIG. 1 is a schematic sectional view of an example of a light detection device of an embodiment.

FIG. 2 is a schematic sectional view of another example of the light detection device of the embodiment.

FIG. 3 is a schematic view of a prior-art light detection device.

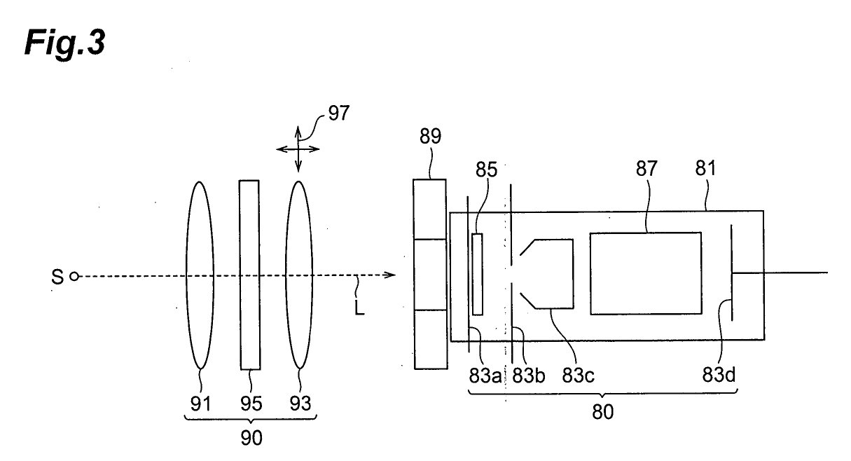

### BEST MODES FOR CARRYING OUT THE INVENTION

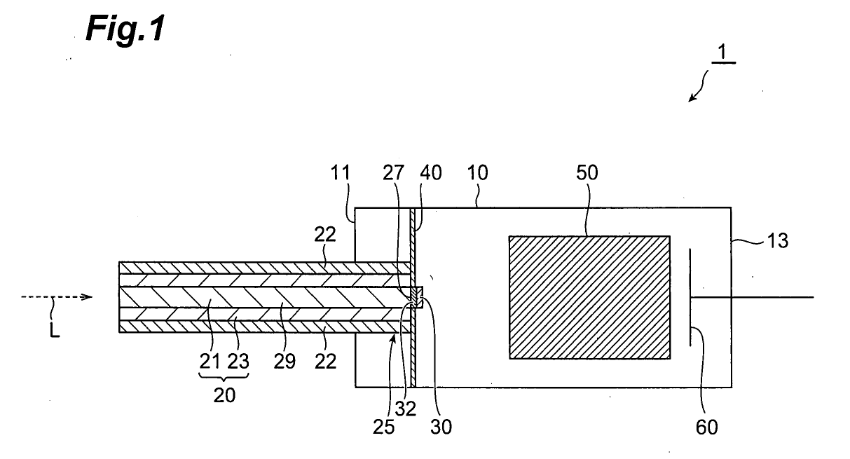

A preferred embodiment of this invention shall now be described using the drawings. FIG. 1 is a schematic sectional view of an example of a light detection device of this embodiment. A light detection device 1 is equipped with a vacuum container 10, formed of a glass tube, the interior of which is put into a vacuum condition, and an optical fiber 20, comprising a core part 21 and a clad layer 23, formed on the periphery of core part 21.

Vacuum container 10 has one end face 11 and another end face 13. An end part 25 of optical fiber 20 is inserted from end face 11 and fixed inside vacuum container 10. At end part 25 is an end face 27 of optical fiber 20. A light signal L, which has propagated through core part 21 from a light source, exits from end face 27. On the core part 21 portion of end face 27 are laminated a substrate metal layer 32, which has been vapor deposited upon roughening the surface at the nanometer level to enable metal to be adsorbed readily, and a photocathode 30, which is an example of a photoelectron emitting part. An external photoemission effect occurs due to photocathode 30. That is, by the incidence of light signal L, exiting from end face 27, onto photocathode 30, photoelectrons are emitted from photocathode 30 into vacuum container 10. As a method of forming photocathode 30 on end face 27, there is, for example, the following method. That is, first, a metal layer is vapor deposited onto end face 27. By patterning this metal layer by photolithography and etching, the metal layer is left just on the core part 21 portion of end face 27. This becomes the substrate metal layer 32. By then selectively vapor depositing the materials of the photocathode onto substrate metal layer 32, photocathode 30 is formed on end face 27.

Inside vacuum container 10, an electrode 40, which is electrically connected to photocathode 30 via substrate metal layer 32, is positioned and also, an electron multiplier 50, is positioned so as to oppose photocathode 30 across a predetermined distance. A known electron multiplier may be used as electron multiplier 50. The structure and materials of electron multiplier 50 are various and since the current multiplication factor, time response characteristics, etc., of light detection device 1 differ according to these, the structure and materials of electron multiplier 50 are selected according to the purpose of use of light detection device 1. Inside vacuum container 10, a readout electrode 60 is positioned between end face 13 and electron multiplier 50, and a part of readout electrode 60 is drawn out to the exterior via end face 13. A photomultiplier tube is arranged from vacuum container 10, photocathode 30, and electron multiplier 50.

The operation of light detection device 1 shall now be described. Light signal L that has propagated through core part 21 of optical fiber 20 is made incident on photocathode 30 via end face 27 of optical fiber 20. Electrons inside photocathode 30 are thereby excited and photoelectrons are emitted into the vacuum (external photoemission effect). The photoelectrons are made incident on electron multiplier 50. Photoelectrons, which are current-multiplied by secondary electron emission being repeated at electron multiplier 50, are sent to readout electrode 60.

With light detection device 1, optical fiber 20, through which light signal L flows, is equipped and photocathode 30 is formed on end face 27 of optical fiber 20. An image forming system, focusing electrode, etc., are thus made unnecessary and the device can be made compact. Also, light propagation and photoelectric conversion can be made high in efficiency.

Also with light detection device 1, since photocathode 30 is formed only on core part 21 of end face 27, the photocathode can be made compact. Since the thermal noise can thus be reduced to the limit, the signal-to-noise ratio in measurement can be made satisfactory. Photoelectric surface 30 may also be formed on core part 21 and on clad layer 23 of end face 27.

The above effects shall now be described specifically using numerical values. With light detection device 1, when for example a multi-mode fiber with which the diameter of core part 21 is 125 μm is used, photocathode 30 will be 1/1600th that of a photocathode with a diameter of 5 mm (photocathode of a normal size) in area ratio. Also for example, with a prior-art type, with which the photocathode is GaAs and a cooling part for the photocathode is equipped, the noise level of the photocathode is approximately 100 cps. With light detection device 1, the thermal noise becomes 0.063 cps.

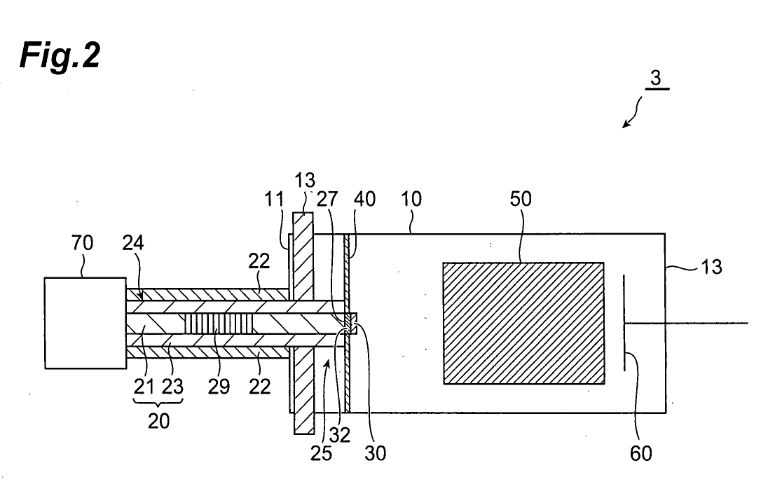

Another example of the light detection device of the present embodiment shall now be described. FIG. 2 is a schematic sectional view of this light detection device 3. With regard to light detection device 3, the differences with respect to light detection device 1, shown in FIG. 1, shall be described. Of the components making up light detection device 3, those that are the same as the components of light detection device 1 shall be provided with the same symbols and description thereof shall be omitted.

A diffraction grating 29 is formed on a part of core part 21 of optical fiber 20. Thus from within a light signal, just the wavelength component that is desired to be measured can be selected. Also, a light shielding cladding 22 is formed on the periphery of optical fiber 20. The leakage of the light signal inside optical fiber 20 to the exterior can thereby be prevented. An FC type optical fiber connector 70 is attached to end part 24 of optical fiber 20 at the opposite side of end part 25. Though photocathode 30 is formed on just core part 21 of end face 27, it may be formed instead on core part 21 and clad layer 23 of end face 27.

A Peltier cooler 13 is positioned in the vicinity of end face 11 and photocathode 30 inside vacuum container 10. Peltier cooler 13 has a through hole and end part 25 of optical fiber 20 is passed through this through hole. Photoelectric surface 30 is cooled by Peltier cooler 13. Thermal noise can thus be reduced. The operation and effects of light detection device 3 are the same as those of light detection device 1.

1. A light detection device comprising:
an optical fiber, having an end face that serves as a light exiting surface; and
a photoelectron emitting part, formed on the end face and emitting photoelectrons based on light exiting from the end face.

2. The light detection device according to claim 1, wherein
the optical fiber includes a core part,
at least a part of the end face includes the core part, and
the photoelectron emitting part is formed only on the core part of the end face.

3. The light detection device according to claim 1, wherein a diffraction grating for wavelength selection is formed in the core part.

4. The light detection device according to claim 1, further comprising a light shielding cladding, disposed on the surface of the optical fiber in order to prevent leakage of light from the optical fiber and intrusion of external light into the optical fiber.

5. The light detection device according to claim 1, wherein the optical fiber includes another end face that serves as a light incidence surface and
the light detection device further comprises an optical fiber connector, which is mounted to the other end face.

6. The light detection device according to claim 1, further comprising a cooling part for lowering the temperature of the photoelectron emitting part.

7. The light detection device according to claim 1, wherein a metal layer is positioned between the end face and the photoelectron emitting part.

8. The light detection device according to claim 1, further comprising a light shielding cladding, disposed on the surface of the optical fiber in order to prevent leakage of light from the optical fiber.
